(19) United States
(12) Patent Application Publication
(10) Pub. No.: US 2023/0132214 A1
(43) Pub. Date: Apr. 27, 2023

(54) INFORMATION PROCESSING APPARATUS AND METHOD OF THE SAME

(71) Applicant: CANON KABUSHIKI KAISHA, Tokyo (JP)

(72) Inventor: Yoko Tokumoto, Chiba (JP)

(21) Appl. No.: 17/969,067

(22) Filed: Oct. 19, 2022

(30) Foreign Application Priority Data
Oct. 25, 2021 (JP) 2021-174067
Jul. 29, 2022 (JP) 2022-122015

(51) Int. Cl. G06F 11/14

(52) U.S. Cl. CPC G06F 11/1469; G06F 11/1417; G06F 11/1433

(57) ABSTRACT

This information processing apparatus performs a secure boot in which a plurality of modules are sequentially booted subsequently to a boot program. The information processing apparatus stores backup data of some of the modules among the plurality of modules as well as verifies the validity of a program of a module to be booted next. When an abnormality of a program is detected, if a verification target is included in the some modules, the information processing apparatus obtains corresponding backup data stored in the information processing apparatus. If the verification target is not included in the some modules, corresponding backup data is obtained from an external unit. In addition, the information processing apparatus restores a program in which an abnormality has been detected using the obtained backup data and boots the corresponding module using a program whose validity has been verified.

### BACKGROUND OF THE INVENTION

### Field of the Invention

The present invention relates to an information processing apparatus and a method of the same.

### Description of the Related Art

Attacks that target software vulnerabilities, tamper with software, and exploit computers are a problem. Also, there is a possibility that program data held in a memory or the like may change due to aging degradation of the memory. As a countermeasure, a method for detecting an abnormality in program data in which a hash value of a program is calculated using a tamper-resistant module and stored, and the hash value of the program is recalculated and verified each time the program is booted has been considered. In addition, it is possible to consider a method for detecting abnormality in any of the respective programs, when the programs are sequentially booted at boot-up without a tamper-resistant module that requires special hardware, by holding a correct value of a subsequent program and performing a comparison with the correct value. In the method for detecting an abnormality of in a program when sequentially booting the programs at boot-up, basically, programs are booted sequentially and the abnormality detection is performed only on the program being booted that time. Hereinafter, in order to simplify the explanation, a mechanism for detecting an abnormality at boot-up will be referred to as a secure boot. A mechanism of a secure boot is starting to be applied to firmware of digital multi function peripherals because of a recent increase in demand for security.

In any case, if a program abnormality is detected during a boot-up, the apparatus will enter in a state in which it is unusable until the abnormal state is resolved. In a case of an apparatus such as a digital multi function peripheral where the user has a contract for maintenance by a serviceperson when the apparatus becomes unusable, it is necessary to resolve the problem by calling a serviceperson and having them restore the apparatus so that the user can use the apparatus again. However, calling a serviceperson every time a problem occurs is inconvenient for the user and there is a cost in calling the serviceperson.

Therefore, providing a mechanism for performing automatic restoration from an abnormal state when an abnormality of software is detected during a boot-up of an information processing apparatus is being considered. For example, it is possible to consider holding backup data of a program of an information processing apparatus and, when an abnormality is detected, performing automatic restoration by replacing a program in which the abnormality has been detected with normal backup data. Japanese Patent Application No. 2002-211460 proposes a technique for performing automatic restoration by backing up first firmware and second firmware, both having a restoration function for each other, in the device or on an external server. In this proposal, a boot-up is switched when a boot-up is not performed normally, and automatic restoration is realized by one of the firmwares flashing the other's backup data.

However, in the above conventional technique, there is a problem, which will be described below. In the above conventional technique, the backup data of the software to be automatically restored is held in the information processing apparatus, and a large-capacity storage area for the backup data is necessary. On the other hand, when the backup data is obtained from outside the information processing apparatus, such as a cloud, it is necessary that the information processing apparatus can boot itself at least to a state in which it can obtain external backup data when an abnormality is detected. However, in the above conventional technique, such a consideration has not been made, and when backup data cannot be obtained from an external unit, it is not possible to perform automatic restoration.

### SUMMARY OF THE INVENTION

The present invention enables realization of an automatic restoration function for when a program abnormality is detected while reducing an amount of memory resources used to hold backup data.

One aspect of the present invention provides an information processing apparatus operable to sequentially boot a plurality of modules subsequently to a boot program, the apparatus comprising: a storage unit configured to store backup data of one or more modules among the plurality of modules; a verification unit configured to verify a validity of a program of a module to be booted next; an obtainment unit configured to, when an abnormality of the program is detected by the verification unit, in a case where a verification target is a module included in the one or more modules, obtain corresponding backup data stored in the storage unit, and in a case where the verification target is a module that is not included in the one or more modules, obtain corresponding backup data from an external unit; an automatic restoration unit configured to restore the program in which the abnormality has been detected, using the backup data obtained by the obtainment unit; and a boot unit configured to boot a corresponding module using a program whose validity has been verified by the verification unit.

Another aspect of the present invention provides a method for booting an information processing apparatus operable to sequentially boot a plurality of modules subsequently to a boot program, the apparatus including a storage unit configured to store backup data of one or more module among the plurality of modules, the method comprising: verifying a validity of a program of a module to be booted next; when an abnormality of the program is detected in the verifying, in a case where a verification target is a module included in the one or more modules, obtaining corresponding backup data stored in the storage unit, and in a case where the verification target is a module that is not included in the one or more modules, obtaining corresponding backup data from an external unit; automatically restoring the program in which the abnormality has been detected, using the obtained backup data; and booting a corresponding module using a program whose validity has been verified.

Further features of the present invention will become apparent from the following description of exemplary embodiments (with reference to the attached drawings).

### BRIEF DESCRIPTION OF THE DRAWINGS

FIG. 1 is a block diagram illustrating a configuration of an information processing apparatus 100 according to an embodiment.

FIG. 2 is a configuration diagram of firmware of the information processing apparatus 100 according to the embodiment.

FIGS. 3A-3B are a flowchart of a secure boot and automatic restoration for an update boot-up according to the embodiment.

FIGS. 4A-4B are a flowchart of a secure boot and automatic restoration for a normal boot-up according to the embodiment.

FIG. 5 is a flowchart of a process for automatically restoring normal boot firmware according to the embodiment.

FIGS. 6A-6B are a diagram illustrating an example of an error display according to the embodiment.

FIG. 7 is a flowchart of a process for obtaining a firmware set for restoration by a PC 260 according to the embodiment.

FIG. 8 is a diagram illustrating an example of a screen of a site for obtaining a set of publicly accessible firmware according to the embodiment.

FIGS. 9A-9B are a flowchart of a restoration process for when an external server 250 is not available according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

<Configuration of Information Processing Apparatus>

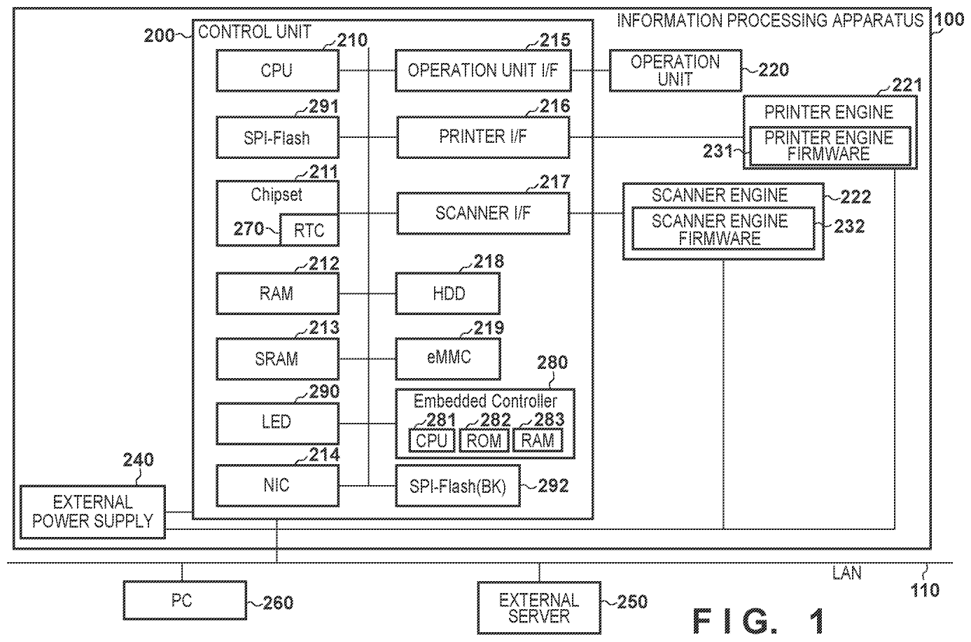

First, an example of a hardware configuration of an information processing apparatus 100 according to the present embodiment will be described with reference to FIG. 1. A description will be given using a multi function peripheral (MFP; a digital multi function peripheral) as an example of an information processing apparatus according to the present embodiment. However, it is not intended to limit the present invention to a multi function peripheral, and the present invention can be applied as long as the apparatus is an information processing apparatus.

The information processing apparatus 100 includes a control unit 200, an operation unit 220, a printer engine 221, a scanner engine 222, and an external power supply 240. The control unit 200 including a CPU 210 controls the operation of the entire information processing apparatus 100. The CPU 210 reads a control program stored in a semiconductor storage apparatus (eMMC) 219 and executes various control processes, such as scan control, print control, and firmware update control. The eMMC 219 is also used as a work area or a user data area. An SPI-Flash 291 stores a BIOS, fixed parameters, a boot program to be executed by an embedded controller 280 to be described later, and the like of the information processing apparatus 100. BIOS is an abbreviation for Basic Input/Output System. The configuration of the present embodiment includes another SPI-Flash (BK) 292 that stores backup data, such as those for the BIOS and the boot program stored in the SPI-Flash 291. A RAM 212 is used as a temporary storage area such as a main memory or a work area of the CPU 210. An SRAM 213 is a non-volatile memory; stores setting values, image adjustment values, and the like necessary for the information processing apparatus 100; and is configured so that the data does not disappear even when the power is turned off and on again. An HDD 218 includes a firmware update file storage area and stores image data, user data, and the like. There are cases where the HDD 218 is not provided, in which case the firmware update file storage area is provided in the eMMC 219 and image data, user data, and the like are all stored in the eMMC 219.

An operation unit I/F 215 connects the operation unit 220 and the control unit 200. The operation unit 220 is provided with a liquid crystal display unit including a touch panel function, a keyboard, and the like. A printer I/F 216 connects the printer engine 221 and the control unit 200. Printer engine firmware 231 is stored in a ROM (not illustrated) provided in the printer engine 221. Image data to be printed by the printer engine 221 is transferred from the control unit 200 to the printer engine 221 via the printer I/F 216 and is printed on a printing medium in the printer engine 221. A scanner I/F 217 connects the scanner engine 222 and the control unit 200. Scanner engine firmware 232 is stored in a ROM (not illustrated) provided in the scanner engine 222. The scanner engine 222 generates image data by reading an image on an original and inputs the image data to the control unit 200 via the scanner I/F 217.

A network I/F card (NIC) 214 connects the control unit 200 (information processing apparatus 100) to a LAN 110. The NIC 214 transmits image data and information to an external apparatus (e.g., an external server 250 or a PC 260) on the LAN 110 and, conversely, receives update firmware and various information. There may be cases where the external server 250 is on the Internet. The information processing apparatus 100 may be operated from a web browser (not illustrated) on the PC 260.

A chipset 211 indicates a set of associated integrated circuits. An RTC 270 is a real-time clock and is a chip dedicated for timekeeping. The external power supply 240 disconnects the power supply according to an instruction from the control program stored in the eMMC 219; however, even if the external power supply 240 is not connected, since the power supply is received from a built-in battery (not illustrated), operation is possible during sleep. Thus, in a state where some power is supplied to the chipset 211, it is possible to realize a return from sleep. On the other hand, the RTC 270 cannot operate in a shutdown state where no power is supplied to the chipset 211. An LED 290 turns on as needed and is used to convey software and hardware abnormalities to the outside.

The embedded controller 280 includes a CPU 281, a ROM 282, and a RAM 283. The CPU 281 in the embedded controller 280 executes a software program that is stored in the ROM 282 when power is supplied. In addition, the CPU 281 executes the boot program stored in the SPI-Flash 291 by deploying the boot program into the RAM 283, which is a random access memory.

<Firmware Configuration>

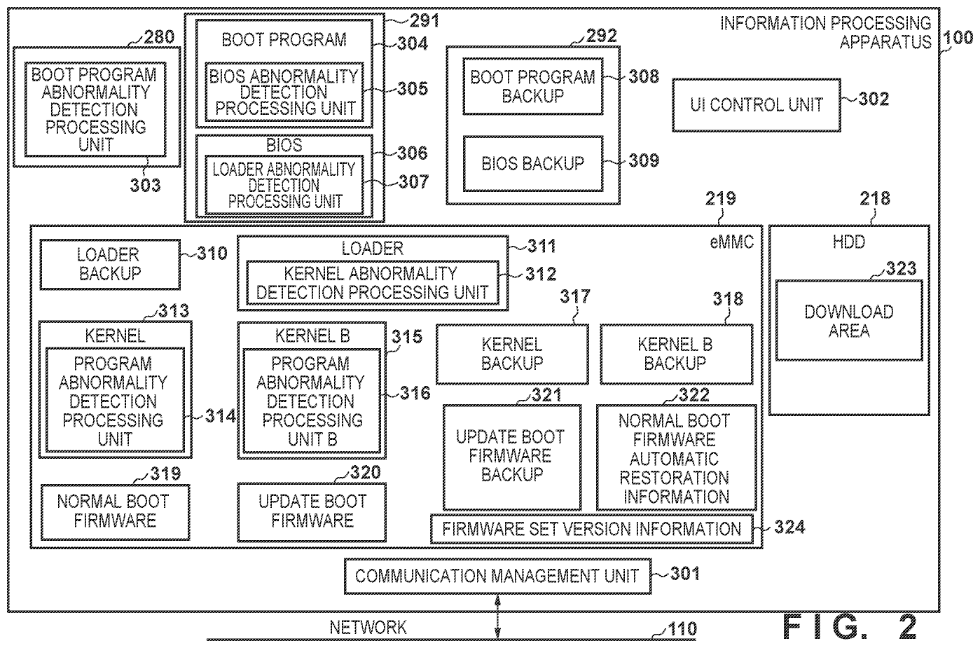

Next, an example of a configuration of a firmware module included in the information processing apparatus 100 according to the present embodiment will be described with reference to FIG. 2.

A communication management unit 301 controls the NIC 214 connected to the LAN (network) 110 to transmit and receive data to and from an external unit via the LAN 110. A UI control unit 302 receives an input to the operation unit 220 through the operation unit I/F 215 and performs processes or screen output according to the input.

A boot program abnormality detection processing unit 303 is stored in the ROM 282 in the embedded controller 280. When the power of the information processing apparatus 100 is turned on and power is supplied, after a boot program 304 stored in the SPI-Flash 291 is deployed in the RAM 283, the boot program abnormality detection processing unit 303 performs a process for detecting an abnormality of the boot program.

The boot program 304 is a program stored in the SPI-Flash 291 and executed by the CPU 281 of the embedded controller 280 and, in addition to performing a process related to a boot-up, includes a BIOS abnormality detection processing unit 305 for detecting an abnormality of the BIOS. A BIOS 306 is a program stored in the SPI-Flash 291 and executed by the CPU 210 after the boot program 304 is executed and, in addition to performing a process related to a boot-up, includes a loader abnormality detection processing unit 307 for detecting an abnormality of a loader.

A boot program backup 308 and a BIOS backup 309 are held in the SPI-Flash (BK) 292 in order to perform an automatic restoration process when an abnormality of the above-described boot program 304 or the BIOS 306 is confirmed. Further, a loader backup 310 is held in the eMMC 219 in order to perform an automatic restoration process when an abnormality of the loader is confirmed in the loader abnormality detection processing unit 307.

A loader 311 is a program that is executed by the CPU 210 after the BIOS 306 has been processed and is stored in the eMMC 219 and, in addition to performing a process related to a boot-up, includes a kernel abnormality detection processing unit 312 for detecting an abnormality of a kernel. A kernel 313 is a program for a normal boot-up as well as a program to be executed by the CPU 210 after the loader 311 has been processed and, in addition to performing a process related to a normal boot-up, includes a program abnormality detection processing unit 314 for detecting an abnormality of normal boot firmware. Further, a kernel B 315 is a program to be executed by the CPU 210 after the loader 311 processing has completed and, in addition to performing a process related to an update boot-up, the kernel B 315 includes a program abnormality detection processing unit B 316 for detecting an abnormality of update boot firmware. For an automatic restoration process for when an abnormality of the kernel is confirmed by the kernel abnormality detection processing unit 312 in the loader 311, a kernel backup 317 and a kernel B backup 318 are held for the kernel 313 and the kernel B 315, respectively.

Normal boot firmware 319 is a program that is executed by the CPU 210 and includes a plurality of programs that provide the respective functions in the information processing apparatus 100. For example, the normal boot firmware 319 includes a program for controlling the scanner I/F 217 and the printer I/F 216, a boot program, and the like. A boot process is performed by the kernel 313 calling the boot program from within the normal boot firmware 319.

Update boot firmware 320 is a program that is executed by the CPU 210 at the time of an update boot-up and includes a plurality of programs, such as a program for updating firmware of the information processing apparatus 100. The update boot firmware 320 includes a function of updating the normal boot firmware 319, the printer engine firmware 231 and the scanner engine firmware 232 described in FIG. 1. Similarly, when a configuration other than a scanner engine or a printer engine, such as a finisher (not illustrated) or the like, is connected as the information processing apparatus 100, the update boot firmware 320 can update corresponding firmware. The update boot firmware 320 includes a function of externally obtaining update firmware for updating firmware. The update firmware can be obtained from an external apparatus (e.g., the external server 250 or the PC 260) on the LAN 110. It is also possible to connect a removable medium (external memory), such as a USB memory, to the information processing apparatus 100 and obtain update firmware from the medium. An update boot firmware backup 321 is held for the above-described program abnormality detection processing unit B 316 in the kernel B 315 to perform an automatic restoration process when an abnormality of the update boot firmware 320 is confirmed.

Backup data is held in the information processing apparatus 100 for automatic restoration for the boot program 304, the BIOS 306, the loader 311, the kernel 313, and the kernel B 315 as programs that are the minimum requirements for a boot-up. By sequentially booting up to the kernel or the kernel B, the information processing apparatus 100 enters a state in which it has booted up to an operating system (OS). However, the functions implemented by application software running on the OS of the information processing apparatus 100 have not yet been booted in the boot-up to this point and, therefore, cannot be used. Specifically, these functions include, for example, a function for mounting and using the necessary areas of the eMMC 219 or the HDD 218, a network function for communicating with an external unit, a function for updating firmware, functions for printing and scanning, and the like. That is, a boot-up of programs up to the kernel or the kernel B does not enable a process for obtaining data from an external unit and performing restoration, so automatic restoration cannot be performed unless backup data is held in the information processing apparatus 100.

Therefore, according to the present embodiment, in addition to the above-described programs that are the minimum requirement for a boot-up, backup data of the update boot firmware 320 is held in the information processing apparatus 100 as application software. The update boot firmware 320 includes a function for mounting the eMMC 219 and the HDD 218, a network function for communicating with an external unit, a firmware update function for obtaining firmware from an external unit and performing an update, and the like. Among application software on the information processing apparatus 100, only backup data of the update boot firmware 320 needs to be stored in the information processing apparatus 100. As a result, backup data of other application software can be obtained from an external apparatus (for example, the external server 250, the PC 260, or an external memory such as a USB memory).

Thus, the information processing apparatus 100 according to the present embodiment backs up programs that are the minimum requirements for a boot-up and the update boot firmware 320 in the information processing apparatus 100 and makes it possible to perform automatic restoration without obtaining the programs from an external unit. The information processing apparatus 100 makes it possible to then obtain application software (in the present embodiment, the normal boot firmware 319) for realizing the other functions on the information processing apparatus 100 from an external unit and perform automatic restoration.

Further, in order to perform an automatic restoration process when an abnormality of the normal boot firmware 319 is confirmed by the program abnormality detection processing unit 314 in the kernel 313 described above, there is normal boot firmware automatic restoration information 322 as non-volatile information in the eMMC 219. A download area 323 is provided in the HDD 218 for temporarily placing downloaded firmware. A combination of each of the above modules for booting the information processing apparatus 100 is handled as a firmware set, versions for the firmware set are provided, and firmware set version information 324 is held in the eMMC 219. In the present embodiment, in terms of the operation of the information processing apparatus 100 being guaranteed, it is assumed that the operation is guaranteed also for a combination of the respective modules as a firmware set. For example, when a user obtains firmware from a site for obtaining publicly accessible firmware, regarding a combination of the respective modules, the user obtains what has been made accessible as a guaranteed firmware set.

The information processing apparatus 100 performs an update while switching boot modes. The boot modes include a normal boot-up (normal mode) in which the kernel 313 and the normal boot firmware 319 operate and an update boot-up (update mode) in which the kernel B 315 and the update boot firmware 320 operate. Each has a function for switching the boot modes, and the loader 311 performs a normal boot-up or an update boot-up according to boot mode information stored in the SRAM 213.

<Secure Boot and Automatic Restoration Process>

Here, a secure boot and an automatic restoration process according to the present embodiment will be described. In a method for a secure boot according to the present embodiment, the boot program 304, the BIOS 306, and the loader 311 are sequentially booted while performing abnormality detection, and in a case of a normal boot-up, the kernel 313 and the normal boot firmware 319 are sequentially booted while performing abnormality detection. That is, program abnormality detection is executed with the next module to be booted as a verification target and the boot process is performed using a program after it has been determined to be normal. In a case of an update boot-up, from the loader 311 onward, the kernel B 315 and the update boot firmware 320 are sequentially booted while performing abnormality detection. When an abnormality is detected, if there is backup data provided in the information processing apparatus 100, a program in which the abnormality has been detected is restored using the backup data, and a boot-up of the next program is continued. The boot program backup 308, the BIOS backup 309, the loader backup 310, the kernel backup 317, and the kernel B backup 318 are held as backup data of the respective programs in the information processing apparatus 100. Further, as backup data, the update boot firmware backup 321 is held in the information processing apparatus 100.

For the normal boot firmware 319, backup data is not held in the information processing apparatus 100. Accordingly, automatic restoration is performed by an equivalent program being obtained from an external unit using a program that can be automatically restored by the above-described backup data in the information processing apparatus 100 and restoration being performed by an update. On the other hand, as described above, the update boot firmware 320 is backed up in advance as the update boot firmware backup 321. When a boot-up is performed with this update boot firmware 320, since it includes a function for communicating with an external unit, it is possible to obtain backup data of the normal boot firmware 319 from an external unit. Therefore, according to the present embodiment, when an abnormality is detected in the normal boot firmware 319, a reboot is performed with the update boot firmware 320, and the backup data of the normal boot firmware 319 is obtained from an external unit.

It is assumed that the boot program 304 includes a public key for verifying a BIOS, the BIOS 306 includes the BIOS signature and a public key for verifying the loader 311, and the loader 311 includes a loader signature, a public key for verifying the kernel, and a public key for verifying the kernel B. In addition, it is assumed that the kernel 313 includes a kernel signature and a public key for verifying the normal boot firmware, and the normal boot firmware 319 includes a normal boot firmware signature. In addition, it is assumed that the kernel B 315 includes a kernel B signature and a public key for verifying the update boot firmware, and the update boot firmware 320 includes an update boot firmware signature. It is assumed that these public keys and signatures are provided to the programs in advance prior to shipment of the information processing apparatus 100. A boot-up (secure boot) of the information processing apparatus 100, in which abnormality detection is performed by verification units of reference numerals 303, 305, 307, 312, 314, and 316 verifying the respective programs and, if there is no problem, booting the next program, is performed.

<Secure Boot at Time of Update Boot-Up>

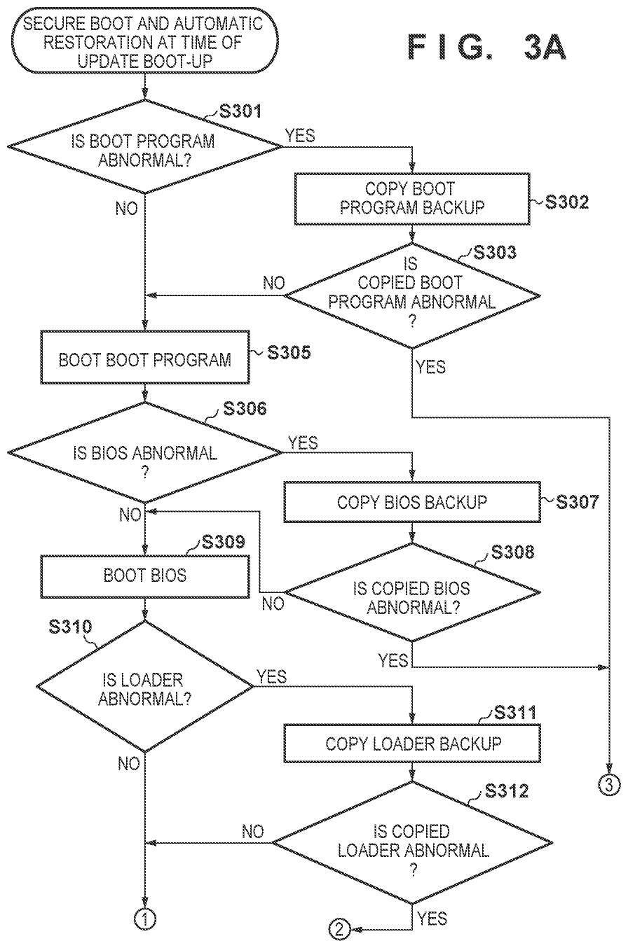

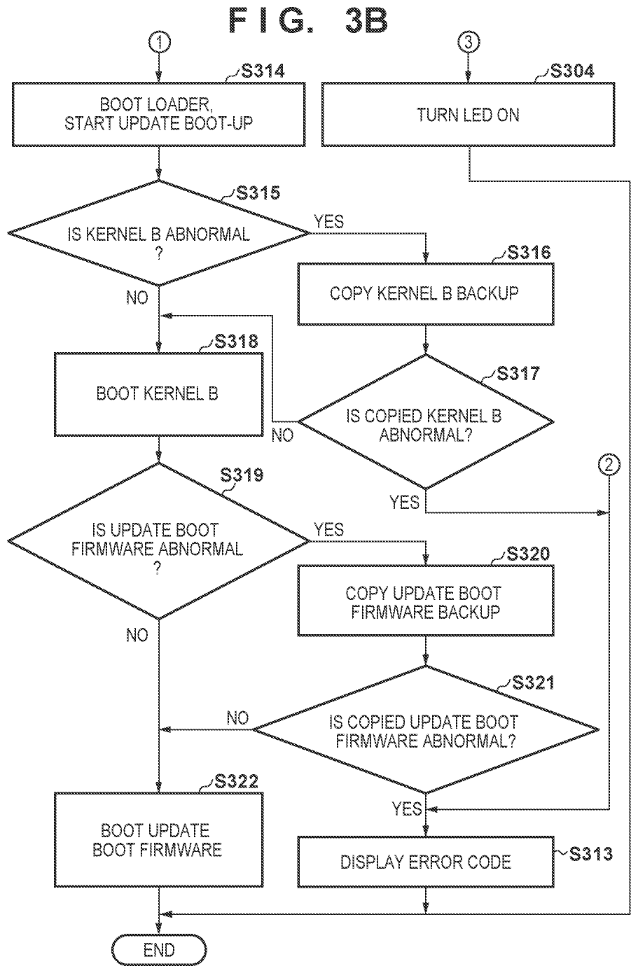

Next, a processing procedure for a secure boot at the time of an update boot-up in the information processing apparatus 100 according to the present embodiment will be described with reference to FIGS. 3A-3B. When the power of the information processing apparatus 100 is turned on, the CPU 281 in the embedded controller 280 executes the boot program abnormality detection processing unit 303, which is stored in the ROM 282 when power is supplied.

In step S301, the CPU 281 deploys the boot program 304 stored in the SPI-Flash 291 in the RAM 283 and verifies the validity of the boot program 304. If an abnormality is detected, the process proceeds to step S302; if not, the process proceeds to step S305. In step S302, the CPU 281 copies the boot program backup 308 stored in SPI-Flash (BK) 292 and overwrites the boot program 304 of the SPI-Flash 291 in which the abnormality has been detected. Next, in step S303, the CPU 281 verifies the boot program 304, which has been copied from the backup, by the boot program abnormality detection processing unit 303 again. If the boot program 304 copied from the backup is not successfully verified, the process proceeds to step S304, and the CPU 281 turns the LED 290 on and terminates this process. On the other hand, if the verification is successful in step S303, the process proceeds to step S305.

In step S305, the CPU 281 boots and executes the boot program 304. Here, the BIOS abnormality detection processing unit 305 included in the boot program 304 reads the BIOS 306, the public key for verifying the loader, and the BIOS signature from the SPI-Flash 291 into the RAM 283. Next, in step S306, the BIOS abnormality detection processing unit 305 verifies the BIOS signature using the public key for verifying the BIOS and determines whether or not the verification is successful. When the signature is not successfully verified, the process proceeds to step S307, and the BIOS abnormality detection processing unit 305 copies the BIOS backup 309 stored in the SPI-Flash (BK) 292 and rewrites the BIOS 306 in which an abnormality has been detected. Thereafter, in step S308, the BIOS abnormality detection processing unit 305 verifies the BIOS 306 copied from the backup again. If the signature of the BIOS 306 copied from the backup is not successfully verified, the process proceeds to step S304, and the BIOS abnormality detection processing unit 305 turns the LED 290 on and terminates this process. On the other hand, when the signature is successfully verified, the BIOS abnormality detection processing unit 305 supplies the CPU 210 with power, terminates the process for the boot program, and advances the process to step S309. The process up to this point is performed by the CPU 281 of the embedded controller 280.

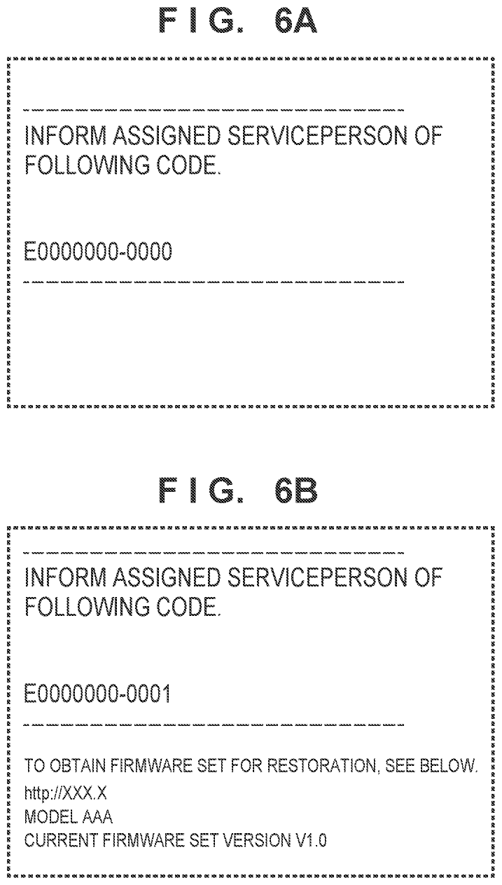

When supplied with power in step S309, the CPU 210 reads the BIOS 306 and the public key for verifying the loader from the SPI-Flash 291 into the RAM 212 and boots the BIOS 306. All subsequent processes are described as being performed by the CPU 210. When booted, the BIOS 306 performs various initialization processes, and the loader abnormality detection processing unit 307 included in the BIOS 306 reads the loader 311, the public key for verifying the kernel, and the loader signature from the eMMC 219 into the RAM 212. Next, in step S310, the loader abnormality detection processing unit 307 verifies the loader signature using the public key for verifying the loader and determines whether or not the verification is successful. If the signature is not successfully verified, the process proceeds to step S311; if it is successfully verified, the process proceeds to step S314. In step S311, the loader abnormality detection processing unit 307 copies the loader backup 310 and rewrites the loader 311, which has been detected to have been tampered with. Next, in step S312, the loader abnormality detection processing unit 307 verifies the loader 311 copied from the backup again. When signature of the loader 311 copied from the backup is not successfully verified, the process proceeds to step S313, and the loader abnormality detection processing unit 307 displays an error code of FIG. 6A on the operation unit 220 and terminates this process. When the signature is successfully verified, the loader abnormality detection processing unit 307 terminates the process and the BIOS 306 boots the loader 311 which has been read into the RAM 212.

When booted in step S314, the loader 311 performs various initialization processes and confirms a flag, such as that of a boot mode, by referring to the SRAM 213. In the present embodiment, a description will be given using an example of an update boot-up, and so, it is assumed that a flag for selecting a boot mode of an update boot-up for booting the kernel B 315 and the update boot firmware 320 is set in the SRAM 213. Thus, the loader 311 starts booting the kernel B 315 for an update boot-up. The kernel abnormality detection processing unit 312 included in the loader 311 reads the kernel B 315, the public key for verifying the update boot firmware, and the kernel B signature from the eMMC 219 into the RAM 212. Next, in step S315, the kernel abnormality detection processing unit 312 verifies the kernel B signature using the public key for verifying the kernel B and determines whether or not the verification is successful. If the signature is not successfully verified, the process proceeds to step S316; if it is successfully verified, the process proceeds to step S318.

In step S316, the kernel abnormality detection processing unit 312 copies the kernel B backup 318 and rewrites the kernel B 315 in which an abnormality has been detected. Next, in step S317, the kernel abnormality detection processing unit 312 verifies the kernel B 315 copied from the backup again. When signature of the kernel B 315 copied from the backup is not successfully verified, the process proceeds to step S313, and the kernel abnormality detection processing unit 312 displays the error code of FIG. 6A on the operation unit 220 and terminates this process. On the other hand, when the signature is successfully verified, the kernel abnormality detection processing unit 312 terminates the process, the process proceeds to step S318, and the loader 311 boots the kernel B 315 which has been read into the RAM 212.

When booted, the kernel B 315 performs various initialization processes. The program abnormality detection processing unit B 316 included in the kernel B 315 then loads the update boot firmware 320 and the update boot firmware signature from the eMMC 219 into the RAM 212. When the programs up to the kernel B 315 have been booted, the information processing apparatus 100 enters a state in which the programs up to the OS have been booted. However, the application software (update boot firmware 320) to be booted on the OS has not yet been booted. Therefore, a mounting process, a process for communicating with an external unit over a network, a firmware update process, and the like cannot yet be performed at this stage.

Next, in step S319, the program abnormality detection processing unit B 316 verifies the update boot firmware signature using the public key for verifying the update boot firmware and determines whether it has been successful. If the signature is not successfully verified, the process proceeds to step S320; if it is successfully verified, the process proceeds to step S322. In step S320, the program abnormality detection processing unit B 316 copies the update boot firmware backup 321 and rewrites the update boot firmware 320 in which an abnormality has been detected. Next, in step S321, the program abnormality detection processing unit B 316 verifies the update boot firmware 320 copied from the backup again. When signature of the update boot firmware 320 copied from the backup is not successfully verified, the process proceeds to step S313, and the program abnormality detection processing unit B 316 displays the error code of FIG. 6A on the operation unit 220 and terminates this process. On the other hand, when the signature is successfully verified, the program abnormality detection processing unit B 316 terminates the process, the update boot firmware 320 is booted in step S322, and the process is terminated.

<Secure Boot at Normal Boot-Up>

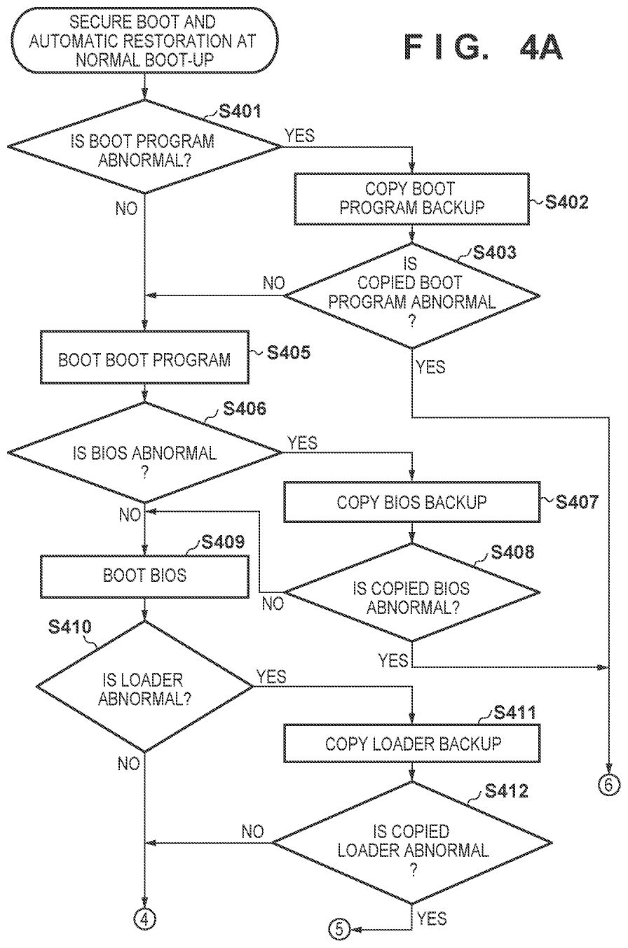

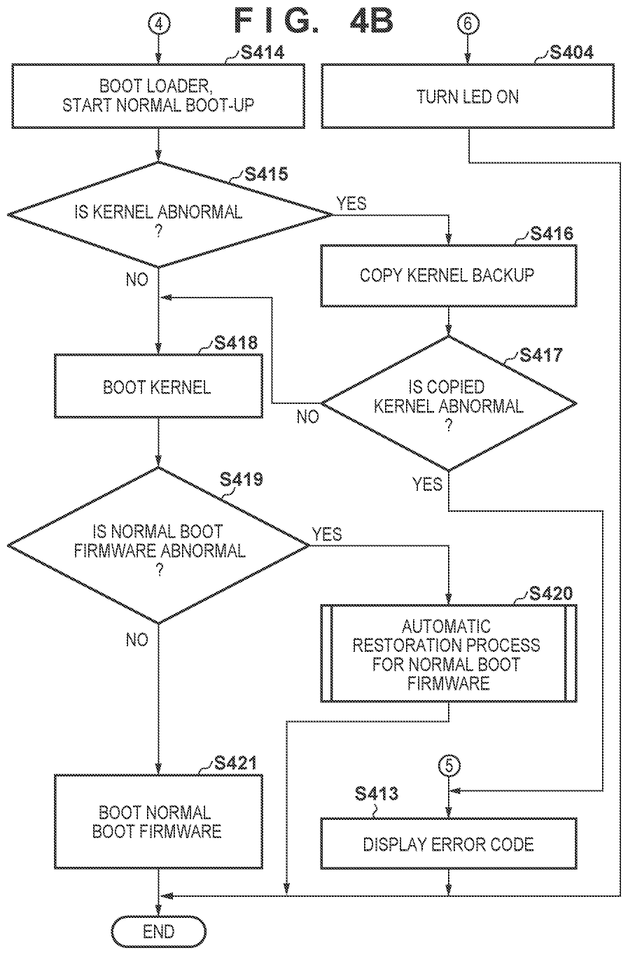

Next, a processing procedure for a secure boot at a normal boot-up in the information processing apparatus 100 according to the present embodiment will be described with reference to FIGS. 4A-4B. Regarding programs for which backup data are held in advance in the information processing apparatus 100, it is possible to detect an abnormality and perform automatic restoration in the same manner as the secure boot at the update boot-up of FIGS. 3A-3B described above. Regarding the process at a normal boot-up, the process for steps S401 to S413 is the same as that of steps S301 to S313 of FIGS. 3A-3B, and in step S414, a flag for selecting a boot mode for a normal boot-up in which the kernel 313 and the normal boot firmware 319 are booted is set in the SRAM 213. Similarly to the kernel B 315 for an update boot-up in steps S315 to S318, after confirming the flag, in steps S415 to S418, the loader 311 performs a process of detecting an abnormality in the kernel 313 for a normal boot-up by the kernel abnormality detection processing unit 312 and, if an abnormality is detected, performs an automatic restoration process. When the verification is successful, a boot-up the kernel 313 for a normal boot-up is started.

When booted, the kernel 313 performs various initialization processes. Next, the program abnormality detection processing unit 314 included in the kernel 313 then loads the normal boot firmware 319 and the normal boot firmware signature from the eMMC 219 into the RAM 212. When the programs up to the kernel 313 have been booted, the information processing apparatus 100 enters a state in which the programs up to the OS have been booted. However, the application software (normal boot firmware 319) to be booted on the OS has not yet been booted. Therefore, at this stage, a mounting process, a process for communicating with an external unit over a network, a process for printing and scanning, and the like for controlling the respective engines connected to the information processing apparatus 100 cannot yet be performed.

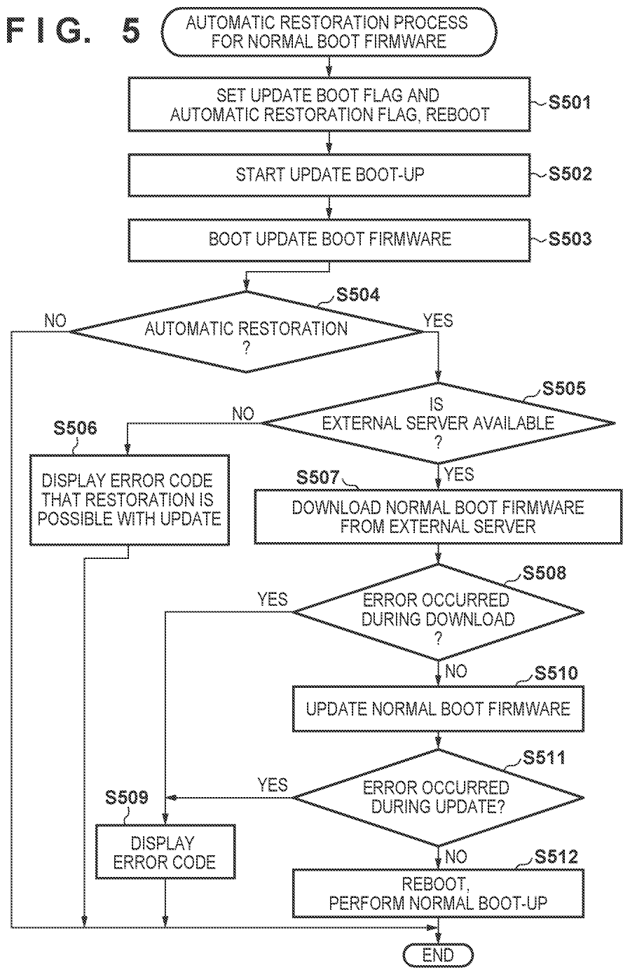

Next, in step S419, the program abnormality detection processing unit 314 verifies the normal boot firmware signature using the public key for verifying the normal boot firmware and determines whether it has been successful. When the signature is not successfully verified, the process proceeds to step S420, and the program abnormality detection processing unit 314 performs a process for automatically restoring the normal boot firmware, which will be described later. The automatic restoration process will be described later with reference to FIG. 5. On the other hand, when the signature is successfully verified, the program abnormality detection processing unit 314 terminates the process, the normal boot firmware 319 is booted in step S421, and the process is terminated.

<Automatic Restoration of Normal Boot Firmware>

Next, a detailed processing procedure of a process for automatically restoring of the normal boot firmware 319 in step S420 of FIG. 4B will be described with reference to FIG. 5. The process to be described below is performed when an abnormality of the normal boot firmware 319 is detected in step S419 of FIG. 4B.

First, in step S501, the program abnormality detection processing unit 314 sets an update boot flag in the SRAM 213 and an automatic restoration flag in the normal boot firmware automatic restoration information 322 and instructs a reboot process. The information processing apparatus 100 starts a reboot and, in step S502, starts an update boot-up. Here the update boot process of steps S301 to S321 of FIGS. 3A-3B is performed, and in step S503, the program abnormality detection processing unit B 316 boots the update boot firmware 320. As described above, in the update boot process of steps S502 and S503, even if there is an abnormality, automatic restoration is performed using the backup data in the information processing apparatus 100, and the boot-up proceeds. Communication with an external unit cannot yet be performed with the programs up to the kernel B 315 being booted at an update boot-up; however, when the process has been completed up to a boot-up of the update boot firmware 320 in step S503, it becomes possible to communicate with an external unit over a network. Therefore, hereinafter, it becomes possible to obtain data equivalent to the normal boot firmware 319 from an external unit. In the process from step S504 and onward, the normal boot firmware 319 in which an abnormality has been detected is automatically restored by obtaining data equivalent to the normal boot firmware 319 from an external unit and performing an update in the process of the update boot firmware 320.

In step S504, the update boot firmware 320 confirms whether or not the automatic restoration flag is set in the normal boot firmware automatic restoration information 322. If the automatic restoration flag is not set, this process is simply terminated. On the other hand, if the automatic restoration flag is set, the process proceeds to step S505, and the update boot firmware 320 confirms whether the external server 250 is available. Whether the external server 250 is available refers to whether settings are such that the information processing apparatus 100 can communicate with the external server 250 on the LAN 110 or the Internet, firmware can be downloaded from the external server 250, and an update can be performed. If the external server 250 is not available, the process proceeds to step S506; an error code display of FIG. 6B, which is different from FIG. 6A, indicating that restoration is possible by updating firmware is performed, and the process is terminated. Thus, it is possible to display, as an error code to a serviceperson that has been called by the user, that although there is a likelihood that restoration from an abnormal state is possible by an update, it cannot be performed due to the external server 250 not being available. Therefore, the serviceperson can confirm the error code as a factor for determining of the restoration method. In this case, for example, the serviceperson can perform the restoration process manually so as to enable communication with the external server 250 and then easily perform the restoration process by resuming the process from step S505, which will be described later. Details of the restoration process will be described later.

In addition to the above error code, connection destination information, such as a URL for obtaining backup data, may be outputted. Thus, it becomes possible to perform the restoration process more easily. For example, when a device detects an abnormality in normal boot firmware, it reboots using update boot firmware and waits in a state in which the user can install update firmware. The user obtains firmware from a displayed URL and updates the normal boot firmware via a remote UI or USB memory. Thus, even if communication with the external server 250 is not available, it is possible to update the normal boot firmware.

On the other hand, when it is determined that the external server 250 is available in step S505, the process proceeds to step S507, and the update boot firmware 320 downloads, from the external server 250, firmware of the same version as the normal boot firmware 319 in which the current abnormality has been detected. In step S508, the update boot firmware 320 determines whether an error has occurred while downloading the firmware from the external server 250. If an error has occurred, the process proceeds to step S509, and the update boot firmware 320 displays the error code of FIG. 6A on the operation unit 220 and terminates the process.

When the firmware has been successfully downloaded, the process proceeds to step S510, and the update boot firmware 320 updates the normal boot firmware 319 in which an abnormality has been detected to the firmware of the same version downloaded from the external server 250. Next, in step S511, the update boot firmware 320 determines whether an error has occurred during the update. If an error has occurred, the process proceeds to step S509, and the update boot firmware 320 displays the error code of FIG. 6A on the operation unit 220 and terminates the process. On the other hand, if the normal boot firmware 319 is successfully updated, the process proceeds to step S512, and the update boot firmware 320 is rebooted to be normally booted.

Through the above process, when there is an abnormality in the normal boot firmware 319 for which backup data is not held in the information processing apparatus 100, an update boot-up is switched to and the normal boot firmware of the same version is obtained from the external server 250. Thus, it becomes possible to perform an update using the obtained normal boot firmware and perform automatically restoration from an abnormal state.

<Restoration Method when Firmware is Obtained by Another Device>

Next, a processing procedure of performing restoration by obtaining firmware by another device of the user in the above-described case in step S506 where the external server 250 is not available will be described. As described above, when the external server 250 is not available, the information processing apparatus 100 cannot download firmware from the external server 250 and perform an update. In such cases where restoration from an abnormal state cannot be performed, it is possible to output connection destination information, such as a URL for obtaining backup data with the error code display illustrated in FIG. 6B. At this time, the user can obtain firmware equivalent to backup data from the displayed URL (such as a site for obtaining publicly accessible firmware, which does not require a contract) via another device. Here, another device is assumed to be the user's PC 260, in which a browser can be used, including a tablet terminal, a smartphone, a personal computer, and the like.

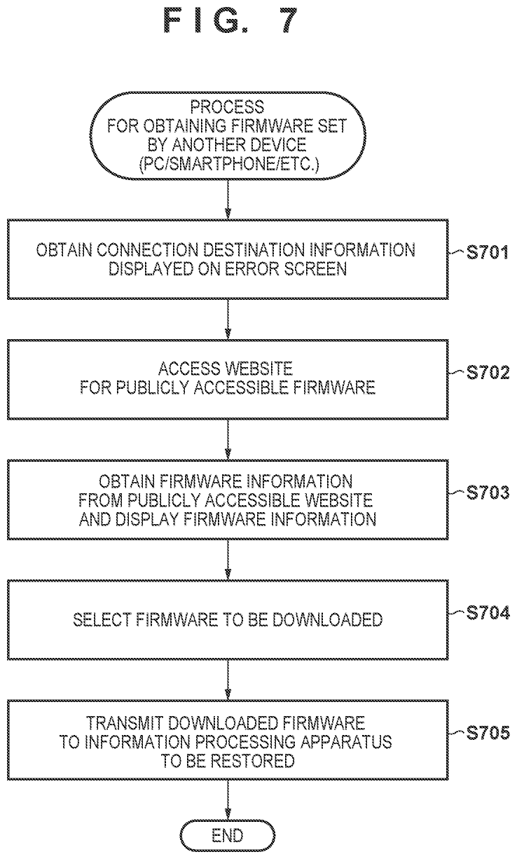

A processing procedure for obtaining restoration firmware in the user's PC 260 will be described with reference to FIG. 7. A process to be described below is realized, for example, by a CPU (not illustrated) of the PC 260 reading and executing a program stored in a memory, such as a ROM, in a RAM.

First, in step S701, the CPU of the PC 260 obtains the connection destination information of FIG. 6B displayed on the operation unit 220 of the information processing apparatus 100. The connection destination information is inputted by accepting a user operation via a user interface of the PC 260. The connection destination information displayed on the operation unit 220 includes model information, current firmware version information, and the like of the information processing apparatus 100 for identifying an appropriate firmware set on a site for obtaining publicly accessible firmware. The display format need not only be a URL and display may be performed in a QR code format. The firmware set being referred to here includes all programs included in the information processing apparatus 100, and it is assumed that versions are provided for the entire firmware set. Of course, there is no intention to limit the present invention, and versions may be provided in other forms.

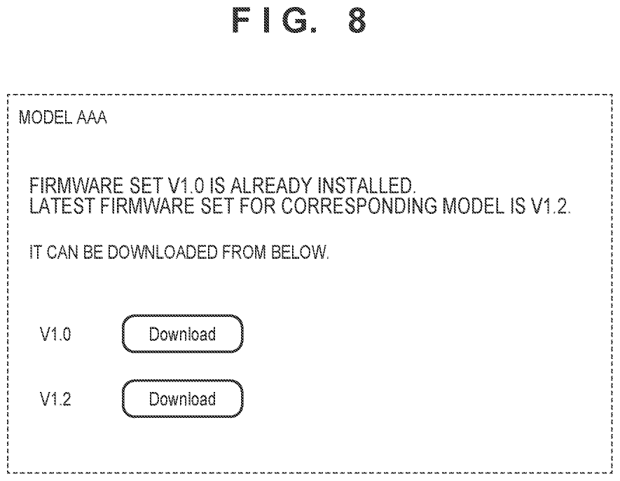

Next, the CPU of the PC 260, in step S702, accesses the site for obtaining publicly accessible firmware based on the connection information inputted through a user operation and, in step S703, obtains and displays information of the firmware set. The site for obtaining publicly accessible firmware displays a firmware set appropriate for restoration based on the transmitted model information and firmware information. FIG. 8 illustrates an example of a screen displayed on a browser on a screen of the PC 260 when a site for publicly accessible firmware is accessed. As illustrated in FIG. 8, in the screen, it is possible to display as downloadable firmware sets not only the firmware set of the same version as that of the information processing apparatus 100 but also the latest firmware set. In this screen, a button for instructing a download is selectably displayed for each version.

It is conceivable that regarding the information processing apparatus 100 for which the external server 250 is not available, a contract for a periodic automatic update has not been concluded as a service maintenance contract and the installed firmware set is not up to date. It is likely that the latest firmware set includes measures against security vulnerabilities, and the user can restore to a more secure firmware set by selecting the latest firmware set. It is also expected that the firmware set version currently used by the user includes faults such as obvious security vulnerabilities and other bugs. In such a case, the site for publicly accessible firmware may be configured so as not to display the firmware set of the version currently installed on the information processing apparatus 100 from the beginning.

Then, the CPU of the PC 260, in step S704, downloads the selected firmware set and, in step S705, transmits the downloaded firmware set from the PC 260 to the information processing apparatus 100 through the LAN 110. Alternatively, a firmware set may be provided by transferring the firmware set to a removable medium (external memory), such as a USB memory, and connecting the external memory to the information processing apparatus 100.

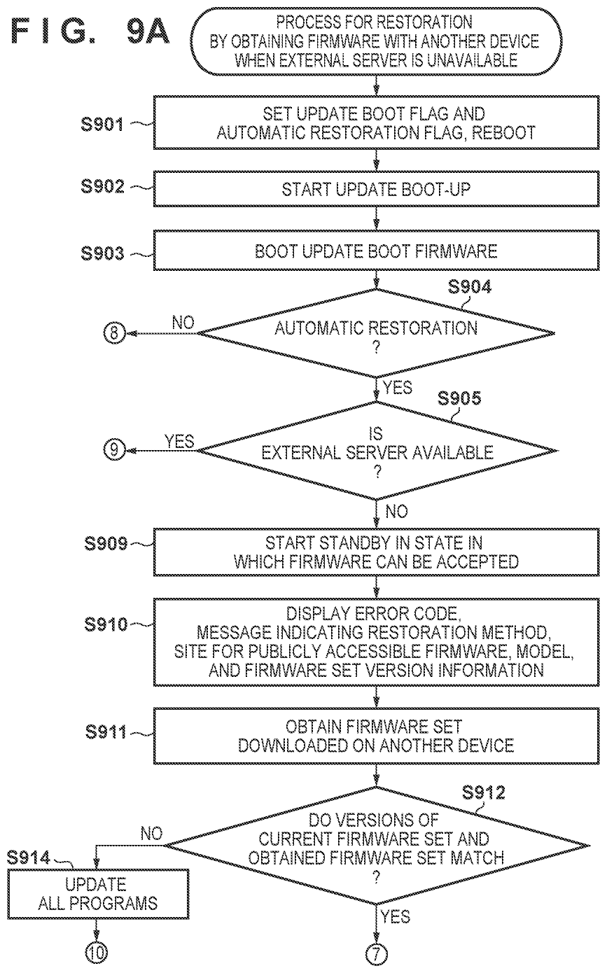

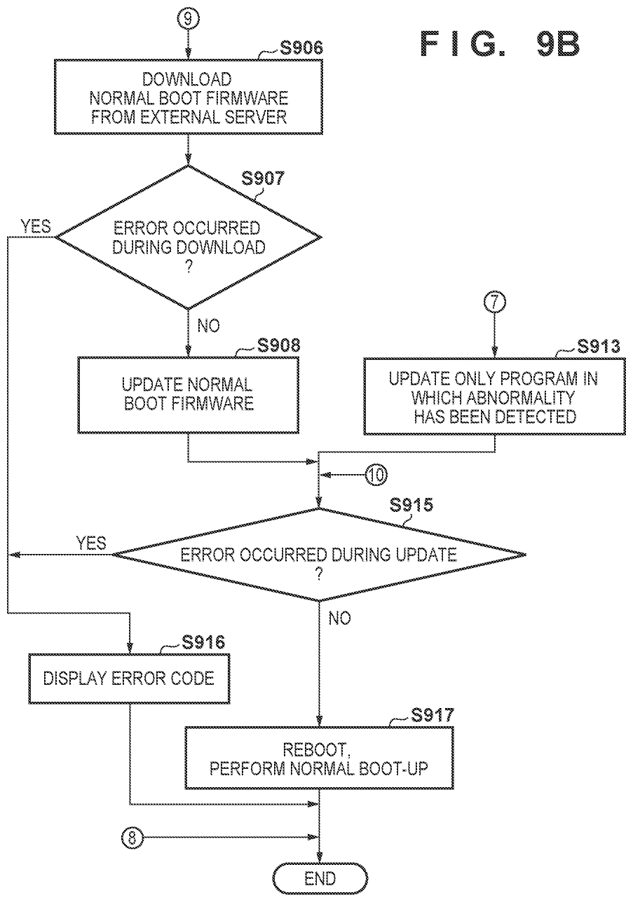

Next, a processing procedure for restoring the information processing apparatus 100 using a firmware set obtained through the PC 260, which is another device, will be described with reference to FIGS. 9A-9B. Regarding steps S901 to S905, since control is the same as that of the above steps S501 to S505, a description thereof will be omitted.

When the update boot firmware 320 determines that the external server 250 is available in step S905, the update boot firmware 320 proceeds to step S906, starts the automatic restoration process for when the external server 250 is available, and performs steps S906, S907, and S908. Regarding steps S906, S907, and S908, since the process is the same as that of steps S507, S508, and S510, the description thereof will be omitted.

On the other hand, if the external server 250 is not available, the process proceeds to step S909, and the update boot firmware 320 starts a standby in a state in which it can accept firmware. Next, in step S910, the update boot firmware 320 displays the error screen of FIG. 6B on the operation unit 220. As described above, on the error screen, information such as a message indicating a restoration method, a site for publicly accessible firmware, a model, and a firmware set version, is displayed along with the error code.

Next, in step S911, the update boot firmware 320 obtains the firmware set downloaded (steps S701 to S705) in another device, such as the PC 260. Next, in step S912, the update boot firmware 320 compares the version of the current firmware set with the version of the firmware set obtained for restoration. Specifically, the firmware set version information 324 is compared with the version information held by the obtained firmware set. If the firmware set versions match, the process proceeds to step S913, and the update boot firmware 320 updates only a program in which an abnormality has been detected in the obtained firmware set. In the present embodiment, it corresponds to the normal boot firmware 319 for which backup data is not held in the information processing apparatus 100.

On the other hand, if the firmware set versions do not match, the process proceeds to step S914, and the update boot firmware 320 updates all the computer programs in the information processing apparatus 100 to the obtained firmware set. This is because if the firmware set version is different from the current one, it is thought that the user has selected and downloaded the latest firmware set on a publicly accessible website. Therefore, all programs are updated to the programs included in the obtained firmware set regardless of whether or not the programs are abnormal. As a result, all the computer programs of the information processing apparatus 100 are updated to the latest firmware set, which makes it possible to restore the information processing apparatus 100 to a more secure state. Regarding steps S915, S916, and S917, since the process is the same as that of steps S511, S509, and S512, respectively, the description thereof will be omitted.

As described above, the information processing apparatus according to the present embodiment performs a secure boot in which a plurality of modules are sequentially booted subsequently to a boot program. The information processing apparatus stores backup data of some of the modules among the plurality of modules as well as verifies the validity of a program of a module to be booted next. Further, when an abnormality of a program is detected, if a verification target is included in the some modules (is one of the modules for which backup data is stored on the information processing apparatus), the information processing apparatus obtains corresponding backup data stored in the information processing apparatus. On the other hand, if the verification target is not included in the some modules (is not one of the modules for which backup data is stored on the information processing apparatus), corresponding backup data is obtained from an external unit. In addition, the information processing apparatus restores a program in which an abnormality has been detected using the obtained backup data and boots the corresponding module using a program whose validity has been verified. As described above, according to the present embodiment, only the backup data of programs (the boot program 304, the BIOS 306, the loader 311, the kernel 313, and the kernel B 315) related to an early stage of a boot-up of the information processing apparatus 100 is held in the information processing apparatus 100. Further, regarding the update boot firmware 320 capable of obtaining a necessary program from an external unit and performing an update, backup data is held in the information processing apparatus 100. This makes it possible to, when there is an abnormality in the normal boot firmware 319 for which backup data is not held in the information processing apparatus 100, switch to an update boot-up, obtain the normal boot firmware of the same version from the external server 250, and perform automatic restoration. Thus, in the present invention, backup data that is the minimum requirement for realizing a communication function is held in advance in the apparatus, and other backup data is obtained from an external unit, which reduces the amount of memory resources used by the backup data. Thus, according to the present invention, it becomes possible to realize an automatic restoration function for when an abnormality of a program is detected, while reducing the amount of memory resources used for holding backup data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-174067, filed Oct. 25, 2021, and Japanese Patent Application No. 2022-122015, filed Jul. 29, 2022, which are hereby incorporated by reference herein in their entirety.

What is claimed is:

1. An information processing apparatus operable to sequentially boot a plurality of modules subsequently to a boot program, the apparatus comprising:
a storage unit configured to store backup data of one or more modules among the plurality of modules;
a verification unit configured to verify a validity of a program of a module to be booted next;
an obtainment unit configured to, when an abnormality of the program is detected by the verification unit, in a case where a verification target is a module included in the one or more modules, obtain corresponding backup data stored in the storage unit, and in a case where the verification target is a module that is not included in the one or more modules, obtain corresponding backup data from an external unit;
an automatic restoration unit configured to restore the program in which the abnormality has been detected, using the backup data obtained by the obtainment unit; and
a boot unit configured to boot a corresponding module using a program whose validity has been verified by the verification unit.

2. The information processing apparatus according to claim 1, wherein the one or more modules include a module that realizes a function of obtaining corresponding backup data from the external unit by the obtainment unit.

3. The information processing apparatus according to claim 1, wherein in a case where the obtainment unit cannot obtain the backup data from the external unit, the obtainment unit outputs a corresponding error code.

4. The information processing apparatus according to claim 3, wherein the obtainment unit further outputs information on a connection destination for obtaining the backup data together with the corresponding error code.

5. The information processing apparatus according to claim 1, wherein
the one or more modules include at least a Basic Input/Output System (BIOS), a loader, a first kernel, and a second kernel, and
in a case where an abnormality has been detected in any of the BIOS, the loader, the first kernel, and the second kernel, the obtainment unit obtains the backup data stored in the storage unit.

6. The information processing apparatus according to claim 1, wherein
the plurality of modules include normal boot firmware that boots in a normal mode and update boot firmware that boots in an update mode, and
the obtainment unit, in a case where an abnormality has been detected in the update boot firmware, obtains the backup data stored in the storage unit, and in a case where an abnormality has been detected in the normal boot firmware, switches from a boot-up according to the normal mode to a boot-up according to the update mode and the update boot firmware obtains, from the external unit, backup data of the normal boot firmware in which the abnormality has been detected.

7. The information processing apparatus according to claim 1, further comprising:
an embedded controller configured to verify a validity of the boot program and, in a case where an abnormality has been detected, perform a restoration using backup data of the boot program stored in the storage unit and boot the boot program.

8. The information processing apparatus according to claim 1, wherein in a case where the obtainment unit obtains the corresponding backup data from the external unit, the obtainment unit obtains the backup data from an external apparatus via a network.

9. The information processing apparatus according to claim 1, wherein in a case where the obtainment unit obtains the corresponding backup data from the external unit, the obtainment unit obtains the backup data from an external memory that is connected to the information processing apparatus.

10. The information processing apparatus according to claim 1, wherein in a case where the obtainment unit obtains the corresponding backup data from the external unit, the obtainment unit obtains not only backup data that corresponds to a program in which there is an abnormality but also, as a firmware set, all programs included in the information processing apparatus.

11. The information processing apparatus according to claim 1, wherein the automatic restoration unit compares a version of a firmware set obtained by the obtainment unit and a version of a firmware set of the information processing apparatus and, in a case where the versions match, restores a program in which an abnormality has been detected and, in a case where the versions do not match, updates all programs included in the information processing apparatus with the obtained firmware set.

12. A method for booting an information processing apparatus operable to sequentially boot a plurality of modules subsequently to a boot program, the apparatus including a storage unit configured to store backup data of one or more module among the plurality of modules, the method comprising:
verifying a validity of a program of a module to be booted next;
when an abnormality of the program is detected in the verifying, in a case where a verification target is a module included in the one or more modules, obtaining corresponding backup data stored in the storage unit, and in a case where the verification target is a module that is not included in the one or more modules, obtaining corresponding backup data from an external unit;
automatically restoring the program in which the abnormality has been detected, using the obtained backup data; and
booting a corresponding module using a program whose validity has been verified.
